(19) United States
(12) Patent Application Publication
(10) Pub. No.: US 2026/0075011 A1
(43) Pub. Date: Mar. 12, 2026

(54) Detecting Conditions To Trigger A Message Generator For Composing Messages

(71) Applicant: Oracle International Corporation, Redwood Shores, CA (US)

(72) Inventors: Jennifer Darmour, Seattle, WA (US); Orry Soegiono, Bellevue, WA (US); Micah Lawler Sonderman, San Antonio, TX (US)

(73) Assignee: Oracle International Corporation, Redwood Shores, CA (US)

(21) Appl. No.: 18/941,155

(22) Filed: Nov. 8, 2024

Related U.S. Application Data
(60) Provisional application No. 63/691,595, filed on Sep. 6, 2024.

(51) Int. Cl. H04L 51/02; G06N 20/00

(52) U.S. Cl. CPC H04L 51/02; G06N 20/00

(57) ABSTRACT

Techniques for generating a system-composed message in response to detecting a dataset that satisfies a trigger for generating a message are disclosed. Initially, the system monitors, in real-time, datasets that are presented in a dashboard and/or are received by the system. The system applies a set of rules or a machine learning model to the datasets that are presented within the dashboard to determine whether the dataset satisfies a trigger for generating a message. In an example, a data type of the dataset is used to determine whether the trigger for generating the message is met. In another example, a date associated with the dataset is used to determine whether the trigger for generating the message is met.

### BENEFIT CLAIMS; RELATED APPLICATIONS; INCORPORATION BY REFERENCE

This application claims the benefit of U.S. Provisional Patent Application No. 63/691,595, filed Sep. 6, 2024, which is hereby incorporated by reference.

### TECHNICAL FIELD

The present disclosure relates to patient management systems. In particular, the present disclosure relates to generating system-composed messages in response to detecting datasets that satisfy triggers for composing messages.

### BACKGROUND

Healthcare providers routinely engage in communication with both patients and non-patients, e.g., colleagues, administrative staff, external partners, etc. Many of these communications are digital, e.g., email, direct message, text message. Communicating with patients and non-patients is vital for coordinating care, ensuring patient safety, and managing the logistics of healthcare delivery.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for generating a message in response to detecting a trigger in accordance with one or more embodiments;

FIG. 3 illustrates a dashboard displaying a system-composed message generated in response to detecting a trigger in accordance with one or more embodiments;

FIG. 4 illustrates a dashboard displaying action items generated in response to a chat conversation in accordance with one or more embodiments; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PATIENT MANAGEMENT SYSTEM ARCHITECTURE
3. GENERATING A MESSAGE IN RESPONSE TO DETECTING A TRIGGER
4. DETERMINING AND DISPLAYING DATASETS RELEVANT TO INCOMING AND OUTGOING MESSAGES
5. DASHBOARD DISPLAYING A SYSTEM GENERATED MESSAGE
6. DASHBOARD DISPLAYING SYSTEM GENERATED ACTION ITEMS
7. PRACTICAL APPLICATIONS, ADVANTAGES & IMPROVEMENTS
8. HARDWARE OVERVIEW
9. MISCELLANEOUS; EXTENSIONS

### 1. General Overview

One or more embodiments generate a system-composed message in response to detecting a dataset that satisfies a trigger for generating a message. Initially, the system monitors, in real-time, datasets that are presented in a dashboard. The system applies a set of rules or a machine learning model to the datasets that are presented within the dashboard to determine whether the dataset satisfies a trigger for generating a message. In an example, a data type of the dataset is used to determine whether the trigger for generating the message is met. In another example, a date associated with the dataset is used to determine whether the trigger for generating the message is met.

When the system detects a trigger based on a dataset (e.g., lab results), the system applies a generative-AI machine learning model to the dataset. The dataset may be received by the system, accessed by a clinician, or displayed in a dashboard. Applying the machine learning model to the dataset generates a system-composed message. The system-composed message is presented to the user for approval. The system may receive feedback corresponding to the system-composed message. Based on the feedback, the machine learning model may be retrained.

In one or more embodiments, feedback for retraining the machine learning model includes modifications made by the user to the system-composed message. The system may present a set of interface elements corresponding to different actions that may be executed by the system. The set of interface elements may include an interface element for displaying a message generation tool. In response to selecting the interface element for displaying the message generation tool, the system presents a system-composed message.

One or more embodiments described in this Specification and/or recited in the claims may not be included in this General Overview section.

### 2. Patient Management System Architecture

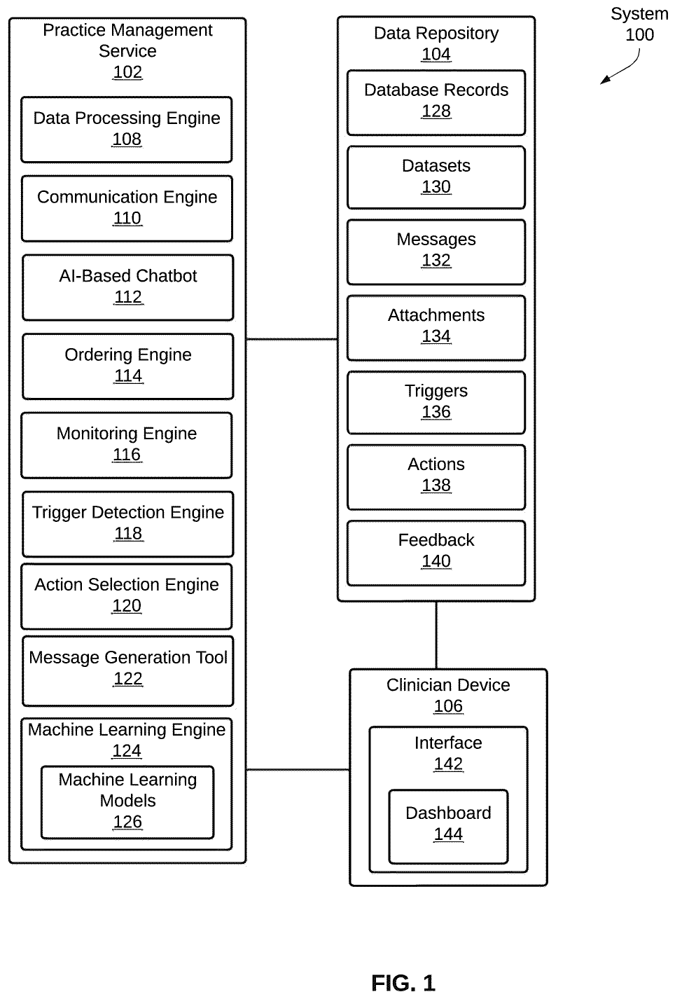

FIG. 1 illustrates a system 100 in accordance with one or more embodiments. As illustrated in FIG. 1, system 100 includes a practice management service 102, a data repository 104, and a clinician device 106. In one or more embodiments, the system 100 may include more or fewer components than the components illustrated in FIG. 1. The components illustrated in FIG. 1 may be local to or remote from one another. The components illustrated in FIG. 1 may be implemented in software and/or hardware. The component may be distributed over multiple applications and/or machines. Multiple components may be combined into one application and/or machine. Operations described with respect to one component may instead be performed by another component.

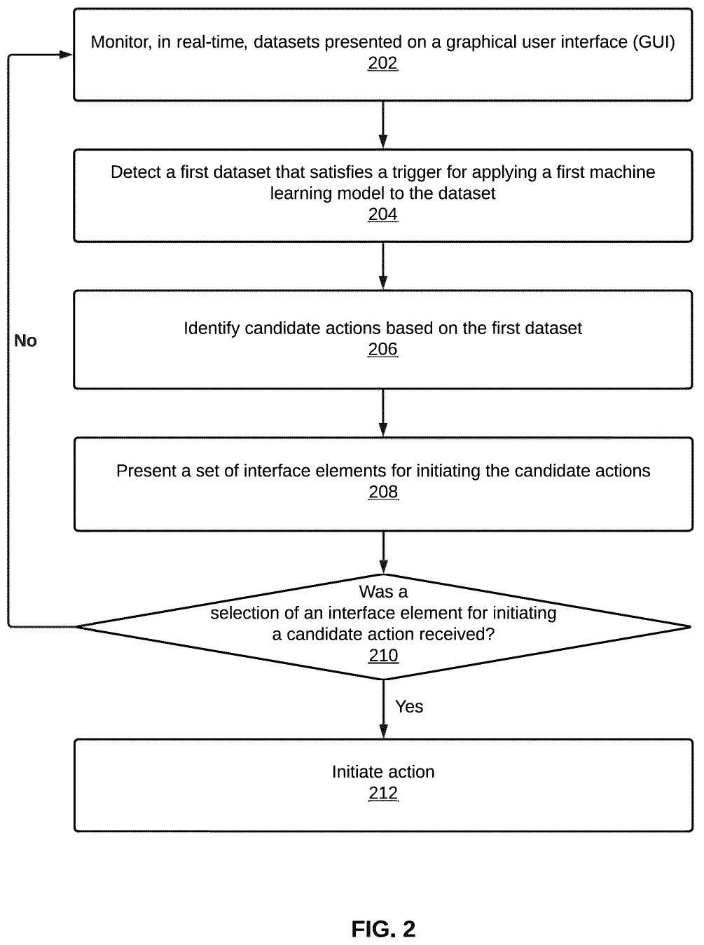

In one or more embodiments, practice management service 102 refers to hardware and/or software configured to perform operations described herein for using machine learning to generate messages in response to detecting datasets that satisfy a trigger for generating a message. Examples of operations for using machine learning to generate messages are described below with reference to FIG. 2.

In an embodiment, practice management service 102 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

In one or more embodiments, the practice management service 102 assists healthcare providers with the following: managing patient information, orders, and appointments; communicating with patients and non-patients; and completing various other tasks necessary for the efficient functioning of the practice. The practice management service 102 includes a data processing engine 108, a communication engine 110, an AI-based chatbot 112, an order engine 114, a monitoring engine 116, a trigger detection engine 118, an action selection engine 120, a message generation tool 122, and a machine learning engine 124.

In one or more embodiments, data processing engine 108 refers to hardware and/or software configured to perform operations described herein for processing and managing patient data within the system 100. The data processing engine 108 ensures that patient data is accurately captured, stored, and analyzed to support various functions, such as patient care, administrative tasks, and decision-making processes.

In one or more embodiments, data processing engine 108 performs various operations, including data ingestion and integration, data transformation and normalization, data storage and management, data analytics and reporting, and real-time data processing. Data ingestion and integration includes collecting data from various sources, such as electronic health records (EHR), lab systems, imaging systems, and patient registration forms as well as integrating data from disparate systems to create a unified patient record. Data transformation and normalization includes transforming raw data into a standardized format that can be easily used and understood across the system and normalizing data to ensure consistency and accuracy, such as converting various date formats into a single standard. Data storage and management includes efficiently storing large volumes of patient data in databases, ensuring quick retrieval and secure access, and managing data lifecycle, including archival and deletion of outdated records in compliance with regulatory requirements. Data analytics and reporting include (1) providing tools for analyzing patient data to generate insights and support clinical decision making and (2) generating reports and dashboards for monitoring practice performance, patient outcomes, and operational efficiency. Real-time data processing includes enabling real-time processing of data for immediate use, such as updating patient records during a clinical encounter, alerting providers to critical lab results, and supporting real-time monitoring and alerts for patient conditions.

In one or more embodiments, communication engine 110 is software and/or hardware configured to perform operations described herein for facilitating communication between clinicians, patients, administrative staff, and others. The communication engine 110 ensures that information is shared promptly and securely, enhancing patient care, improving operational efficiency, and promoting patient engagement.

In one or more embodiments, the communication engine 110 provides secure messaging, patient portals, automated notification and reminders, and integration with EHR. Secure messaging includes medical professional-to-medical professional communication, medical professional-to-patient communication, medical professional-to-non-patient communication, and internal messaging. Patient portals provide patient access to health information, appointment scheduling, and direct messaging. Automated notifications and reminders may include appointment reminders, medication reminders, and follow-up reminders. Integration with EHR includes data synchronization and audit trails.

In one or more embodiments, AI-based chatbot 112 is software and/or hardware configured to perform operations described herein for providing decision support, streamlining administrative tasks, and improving patient care. The AI-based chatbot 112 leverages artificial intelligence, machine learning, and natural language processing (NLP) to assists clinicians in various aspects of the healthcare practice.

In one or more embodiments, the AI-based chatbot 112 provides clinical decision support, EHR integration, appointment management, and task management. Clinical decision support includes symptom assessment, access to clinical guidelines, treatment protocols, best practices, and drug information, e.g., drug interactions, dosages, and side effects. EHR integration includes patient record access and documentation assistance. Task management includes maintaining to-do lists and providing notifications, e.g., alerts for urgent tasks, lab results, or messages from patients.

In one or more embodiments, order engine 114 is software and/or hardware configured to perform operations described herein for creating, managing, and executing medical orders. The order engine 114 automates and optimizes the ordering process, ensuring accuracy, compliance, and timely execution.

In one or more embodiments, a monitoring engine 116 is software and/or hardware configured to perform operations described herein for monitoring datasets. The monitoring engine 116 continuously monitors data from various sources, e.g., patient records, medical devices, or operational systems. Monitoring engine 116 may use machine learning models to recognize normal patterns in datasets and detect deviations that could indicate issues.

In one or more embodiments, a trigger detection engine 118 is software and/or hardware configured to perform operations described herein for identifying specific events or conditions that may necessitate generation of a system-composed message.

In one or more embodiments, action selection engine 120 is software and/or hardware configured to provide actions from a set of possible actions based on specific criteria, rules, or conditions. Action selection engine 120 may use rules based systems, machine learning models, decision trees, or reinforcement learning to evaluate criteria and determine actions to present to a user.

In one or more embodiments, message generation tool 122 is software and/or hardware configured to generate system-composed messages based on datasets. The message generation tool 122 may use predefined templates that are populated with dynamic data, e.g., names, appointment dates, or health information. The message generation tool 122 may use NLP to generate personalized messages. The message generation tool 122 may adjust tone, content, and structure based on, for example, profile information, past interactions, and/or content of datasets. Message generation tool 122 may generate messages directed to patients and non-patients.

In one or more embodiments, one or more components of the practice management service 102 use a machine learning engine 124. Machine learning includes various techniques in the field of AI that deal with computer-implemented, user-independent processes for solving problems that have variable inputs.

In embodiment, the machine learning engine 124 trains a machine learning model 126 to perform one or more operations. Training a machine learning model 126 uses training data to generate a function that, given one or more inputs to the machine learning model 126, computes a corresponding output. The output may correspond to a prediction based on prior machine learning. In some embodiments, the output includes a label, classification, and/or categorization assigned to the provided input(s). The machine learning model 126 corresponds to a learned model for performing the desired operation(s) (e.g., labeling, classifying, and/or categorizing inputs). The practice management service 102 may use multiple machine learning engines 124 and/or multiple machine learning models 126 for different purposes.

In some embodiments, the machine learning engine 124 may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals, whereas other inputs are not associated with supervisory signals. In unsupervised learning, the training data does not include supervisory signals. Reinforcement learning uses a feedback system in which the machine learning engine 124 receives positive and/or negative reinforcement in the process of attempting to solve a particular problem (e.g., to optimize performance in a particular scenario according to one or more predefined performance criteria). In some embodiments, the machine learning engine 124 initially uses supervised learning to train the machine learning model 126 and then uses unsupervised learning to update the machine learning model 126 on an ongoing basis.

In some embodiments, a machine learning engine 124 may use many different techniques to label, classify, and/or categorize inputs. A machine learning engine 124 may transform inputs into feature vectors that describe one or more properties (“features”) of the inputs. The machine learning engine 124 may label, classify, and/or categorize the inputs based on the feature vectors. Additionally, or alternatively, a machine learning engine 124 may use clustering (also referred to as cluster analysis) to identify commonalities in the inputs. The machine learning engine 124 may group (i.e., cluster) the inputs based on those commonalities. The machine learning engine 124 may use hierarchical clustering, k-means clustering, and/or another clustering method or combination thereof. In some embodiments, a machine learning engine 124 includes an artificial neural network. An artificial neural network includes multiple nodes (also referred to as artificial neurons) and edges between nodes. Edges may be associated with corresponding weights that represent the strengths of connections between nodes that the machine learning engine 124 adjusts as machine learning proceeds. Additionally, or alternatively, a machine learning engine 124 may include a support vector machine. A support vector machine represents inputs as vectors. The machine learning engine 124 may label, classify, and/or categorizes inputs based on the vectors. Additionally, or alternatively, the machine learning engine 124 may use a naive Bayes classifier to label, classify, and/or categorize inputs. Additionally, or alternatively, given a particular input, a machine learning model may apply a decision tree to predict an output for the given input. Additionally, or alternatively, a machine learning engine 124 may apply fuzzy logic in situations where labeling, classifying, and/or categorizing an input among a fixed set of mutually exclusive options is impossible or impractical. The aforementioned machine learning model 126 and techniques are discussed for exemplary purposes and should not be construed as limiting some embodiments.

In some embodiments, as a machine learning engine 124 applies different inputs to a machine learning model 126, the corresponding outputs are not always accurate. As an example, the machine learning engine 124 may use supervised learning to train a machine learning model 126. After training the machine learning model 126, if a subsequent input is identical to an input that was included in labeled training data and the output is identical to the supervisory signal in the training data, then output is certain to be accurate. If an input is different from inputs that were included in labeled training data, then the machine learning engine 124 may generate a corresponding output that is inaccurate or of uncertain accuracy. In addition to producing a particular output for a given input, the machine learning engine 124 may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In one or more embodiments, a data repository 104 is any type of storage unit and/or device (e.g., a file system, database, collection of tables, or any other storage mechanism) for storing data. Furthermore, a data repository 104 may include multiple different storage units and/or devices. The multiple different storage units and/or devices may or may not be of the same type or located at the same physical site. Furthermore, a data repository 104 may be implemented or executed on the same computing system as practice management service 102 and clinician device 106. Additionally, or alternatively, a data repository 104 may be implemented or executed on a computing system separate from practice management service 102 and clinician device 106. The data repository 104 may be communicatively coupled to practice management service 102 and clinician device 106 via a direct connection or via a network.

Information describing the practice management service 102 may be implemented across any of components within the system 100. However, this information is illustrated within the data repository 104 for purposes of clarity and explanation.

In some embodiments, data repository 104 includes database records 128, datasets 130, messages 132, attachments 134, triggers 136, actions 138, and feedback 140.

In one or more embodiments, database records 128 are electronic records containing patient data. Patient data refers to any information about a patient that is collected during the course of the healthcare of the patient. Database records 128 may be received from a variety of sources and may include a wide range of information types. Patient data may include demographic data, e.g., age, gender, ethnicity, address, and contact details; medical history, e.g., records of past medical conditions, surgeries, treatments, and hospitalizations; clinical data, e.g., information obtained from medical examinations, including physical exams, vital signs, and symptoms; diagnostic data, e.g., results from laboratory tests (blood tests, urine tests, etc.), imaging studies (X-rays, MRIs, CT scans), and pathology reports; and, medication data, e.g., details about current and past medications, including dosages, frequency, and any adverse reactions or allergies. Database records 128 may also include treatment data, e.g., information about ongoing treatments, including surgeries, therapies, and other interventions; progress notes, e.g., notes made by healthcare providers documenting patient encounters, observations, and treatment plans; administrative data, e.g., information related to healthcare administration, such as insurance details, billing records, and appointment schedules; behavioral data, e.g., information about lifestyle factors, such as smoking status, alcohol consumption, diet, and exercise habits; and patient-generated data, e.g., data collected directly from patients, such as through surveys, wearable devices, or home monitoring equipment.

In one or more embodiments, patient data in the database records 128 may be received from and/or stored in electronic health records (EHRs), personal health records (PHRs), laboratory information systems (LIS), radiology information systems (RIS), picture archiving and communication systems (PACS), pharmacy information systems (PIS), wearable devices and remote monitoring systems, patient portals, insurance claim data, and Health Information Exchanges (HIEs). EHRs are digital versions of patients'paper charts that provide real-time, patient-centered records accessible to authorized healthcare providers. PHRs are health records maintained by patients themselves, often through digital platforms or mobile apps. LIS are systems that manage lab test orders and results, integrating with EHRs and other hospital information systems. RIS and PACS are systems that manage radiological records and imaging data. PIS are systems that manage medication orders, dispensing, and inventory in healthcare settings. Wearable devices and remote monitoring systems include various devices, such as fitness trackers, heart rate monitors, and glucose monitors, that collect health data outside traditional healthcare settings. Patient portals are online platforms that provide patients with access to their health information, appointment scheduling, and communication with healthcare providers. Insurance claims data is data generated from insurance claims that provide information on diagnoses, treatments, and healthcare utilization. HIEs are networks that enable the sharing of health information across different healthcare organizations and systems.

In one or more embodiments, datasets 130 are collections of patient information. Datasets 130 may be received from various sources and may be stored in the database records 128. Datasets 130 may be retrieved from the database records 128 and are viewable by a clinician on a dashboard. Datasets 130 include any form of patient data and medical information.

In one or more embodiments, datasets 130 include laboratory results, imaging and radiology reports, pathology results, and medication records. Laboratory results include blood tests, e.g., complete blood count (CBC), electrolytes, liver function tests, lipid panels, etc.; urine tests, e.g., urinalysis, urine culture; microbiology results, e.g., cultures, sensitivities, and other results related to infectious agents; and genetic tests, e.g., results from genetic or genomic testing, including markers for specific conditions. Imaging and radiology reports include X-rays, e.g., images and interpretations; CT scans, e.g., detailed cross-sectional images; magnetic resonance imaging results; ultrasound, e.g., sonographic images and interpretations; and nuclear medicine, e.g., PET scans, bone scans. Pathology results include biopsy reports, e.g., histological findings from tissue samples; cytology, e.g., results from examining cells, such as Pap smears; and molecular pathology, e.g., results from tests like PCR, FISH, or other molecular assays. Medication records include current medications, e.g., a list of the prescribed, over-the-counter, and herbal medications; medication history, e.g., previous prescriptions, including doses and duration of use; and allergies and adverse reactions, e.g., documented drug allergies and any adverse reactions to medications.

In one or more embodiments, datasets 130 include treatment plans and orders, procedural and surgical records, and clinical notes and documentation. Treatment plans and orders include care plans, e.g., detailed treatment plans developed by healthcare providers, and orders, e.g., prescriptions, lab test orders, imaging orders, referrals to specialists. Procedural and surgical records include procedure notes, e.g., documentation of minor procedures, such as catheter insertions or wound care, as well as surgical reports, e.g., detailed reports from surgeries, including the type of surgery, findings, and outcomes. Clinical notes and documentation include progress notes, e.g., daily or visit-specific notes written by healthcare providers; discharge summaries, e.g., a summary of the patient's hospital stay, including final diagnoses, treatment provided, and follow-up instructions; and consultation notes, e.g., notes from specialist consultations.

In one or more embodiments, datasets 130 include vital signs and monitoring data, patient-reported outcomes, mental health data, and social and behavioral data. Vital signs and monitoring data include continuous monitoring, e.g., data from devices like heart monitors, blood glucose monitors, and wearable devices, as well as periodic measurements, e.g., routine vital signs taken during clinic visits or hospital stays. Patient-reported outcomes include surveys and questionnaires, e.g., information provided directly by the patient regarding symptoms, quality of life, and treatment satisfaction; pain scores, e.g., self-reported pain levels; and functional status, e.g., assessments of mobility, daily living activities, and cognitive function. Mental health data includes psychiatric evaluations, e.g., assessments of mental health, including diagnoses like depression or anxiety; counseling notes, e.g., documentation from therapy or counseling sessions; and psychometric test results, e.g., results from standardized tests like the MMPI or Beck Depression Inventory. Social and behavioral data includes lifestyle factors, e.g., smoking status, alcohol use, diet, exercise habits; social determinants of health, e.g., information about the patient's living situation, employment status, and access to healthcare resources; and substance use history, e.g., documentation of any history of substance abuse.

In one or more embodiments, messages 132 include electronic communications between clinicians and patients, electronic communications between clinicians and non-patients, and communications received from AI chatbots. Messages 132 may include email, text messages, or chat messages received in chat conversations. Messages 132 may be sent and received through direct messaging services, patient portals, email services. Messages 132 may be directed to other healthcare providers, e.g., consultations, referrals, care coordination, sharing patient record; administrative staff, e.g. scheduling, resource management, policy implementation, reporting issues; insurance companies, e.g., pre-authorization requests, claims and billing inquiries, medical necessity documentation; laboratories and diagnostic centers, e.g., test orders, result inquiries, specimen handling instructions; pharmacies, e.g., prescription orders, medication adjustments, clarification requests, reporting adverse reactions; regulatory bodies and public health agencies, e.g., mandatory reporting, compliance documentation, public health alerts; and research institutions and academic collaborators, e.g., research collaboration, data sharing, study participation request, manuscript and publication coordination.

In one or more embodiments, messages 132 are system-composed messages generated by the message generation tool 122. System-composed messages may be generated using datasets 130 available from the database records 128.

In one or more embodiments, attachments 134 are files or documents that are included with a message, email, or other form of digital communication. Attachments 134 may include pdfs, spreadsheets, images, audio files, video files, compressed files, executable files, and/or specialized files, e.g., CAD files. Attachments 134 may be viewed on a dashboard and may be stored and retrieved from database records 128.

In one or more embodiments, triggers 136 are a codified set of rules and/or a set of automatically learned patterns that capture one or more conditions for prompting generation of a system-composed message. Triggers 136 may relate to updates of clinical data in database records 128. For example, triggers 136 may include updates to the database records 128 of datasets 130. The datasets 130 may include abnormal lab results, abnormal vital signs, diagnostic imaging results, and updated symptom reports. For example, updates including lab values outside normal ranges, e.g., high blood glucose levels, may trigger generation of a message to the patient reporting the findings and scheduling a follow-up appointment. Abnormal vital signs, e.g., high blood pressure or low oxygen saturation, may trigger generation message of a message to the patient requesting scheduling of further tests. In another example, receipt of an abnormal lab result, e.g., blood test showing high potassium levels (hyperkalemia), triggers the system to generate a message to the patient for a repeat test and suggesting reducing sodium intake. Triggers 136 may result from the system receiving the dataset 130, i.e., results from a laboratory, or a clinician viewing the update, i.e., on a dashboard of a GUI.

In one or more embodiments, triggers 136 are based, at least in part, on updates to treatment and protocol guidelines. Treatment protocols and guidelines include standardized care protocols and preventative care guidelines. A standardized care protocol may include clinical pathways for specific conditions, e.g., initiating anticoagulation therapy for patients diagnosed with atrial fibrillation. An update to patient data that includes a diagnosis of atrial fibrillation may trigger generation of a message to a patient recommending anticoagulation therapy. Preventive care guidelines may include routine orders based on age and health status, e.g., vaccination reminders for flu shots. Updates to the patient data based on lapsed time or age of the patient may include a status update for test results from “up-to-date” to “outdated”. In an example, a dataset including an update to patient data indicating the patient is diabetic may trigger the system to generate a message to a patient to schedule an HbA1c test.

In one or more embodiments, triggers 136 are based, at least in part, on medication management or disease management. Medication management may include medication reconciliation or drug interaction notification. Detecting discrepancies or needs for refills, e.g., patient reaching the end of a prescription course, may trigger a message reminding the patient of an order refill. Identifying potential drug-interactions may prompt a message to the patient to avoid particular medications. Disease management includes chronic disease monitoring. Markers indicating disease progression, e.g., increasing PSA levels in prostate cancer, may prompt generation of a message requesting further diagnostic tests.

In one or embodiments, triggers 136 are based, at least in part, on procedural and post-operative care or system alerts and reminders. Procedural and post-operative care may include post-operative monitoring and procedure follow-ups. Generation of messages for standard post-surgical orders, e.g., pain management, wound care, may be triggered by a dataset updating the patient data following a procedure. System-composed messages for follow-up on tests may be triggered based on the type of procedure performed, e.g., follow-up colonoscopy based on previous findings. System alerts and reminders include scheduled maintenance and missed appointments. Routine health maintenance checks, e.g., annual physical exams, regular mammograms, may be triggered after the passage of time. Detection of a missed appointment may trigger generation of a message for rescheduling.

In one or more embodiments, triggers 136 are based, at least in part, on patient data integration or administration. Patient data integration includes responses to datasets provided by wearable devices and remote monitoring systems. For example, datasets provided by wearable devices, e.g., continuous glucose monitors showing hyperglycemia, may trigger generation of a system composed message for medication adjustment. Administrative triggers include insurance requirements and discharge planning. Compliance with insurance protocols, e.g., pre-authorization for certain tests or treatments, may trigger generation of a message.

In one or more embodiments, actions 138 are tasks, procedures, and/or operations that clinicians and administrative staff may perform in response to patient information, i.e., datasets. Actions 138 are designed to streamline and optimize patient care, record-keeping, and overall healthcare management. Actions 138 include generating and executing medical orders, generating system-composed messages, scheduling appointments, generating referrals, conferring with insurance companies, and consulting with colleagues. Clinicians may launch tools for performing actions 138 by selecting interface elements presented in a dashboard that represent the actions 138.

In one or more embodiments, feedback 140 may be provided for a system-composed message generated by the message generation tool 122. Feedback 140 may include amendments or alterations by the clinician to a system-composed message provided by message generation tool 122. Material added to or removed from a system-composed message based on a dataset may be used to update the content of future system-composed messages. Feedback 140 associated with a system-composed message may be provided by a clinician or other independent reviewer at a later time. Feedback 140 may be received directly from the clinician in the form of a survey.

In one or more embodiments, clinician device 106 is a digital device that includes an interface 142. Interface 142 refers to hardware and/or software configured to facilitate communications between a user and practice management service 102. Interface 142 displays one or more dashboards 144, renders user interface elements, and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 142 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 150 is specified in one or more other languages, such as Java, C, or C++.

### 3. Generating a Message in Response to Detecting a Trigger

FIG. 2 illustrates an example set of operations for generating a system-composed message in response to detecting a dataset that triggers message generation in accordance with one or more embodiments. One or more operations illustrated in FIG. 2 may be modified, rearranged, or omitted. Accordingly, the particular sequence of operations illustrated in FIG. 2 should not be construed as limiting the scope of one or more embodiments.

One or more embodiments monitor, in real-time, datasets presented on a GUI (Operation 202). Datasets may be received from various sources and include different types of patient information. The system may display the content of the datasets in a GUI as the datasets are received. Alternatively, the datasets may be retrieved from database records by the clinician. The datasets may be presented with interface elements for manipulating or otherwise rearranging the datasets.

In one or more embodiments, various techniques are used for monitoring the datasets presented on the GUI. The system may monitor the datasets presented in the GUI using element detection and classification, text recognition, interaction monitoring, contextual analysis, template matching and heuristics, data structure recognition, and/or integration with backend data. The system may use computer vision techniques, often powered by convolutional neural networks (CNNs), e.g., YOLO, SSD, or Faster R-CNN, to detect and classify GUI components. GUI components may include tables, charts, buttons, dropdowns, text fields, and other interactive elements. When a dataset is presented in a tabular format or as part of a chart or graph, optical character recognition (OCR) may be used to extract the text from the GUI elements. OCR engines like Tesseract can convert images of text within the GUI into machine-readable text. The system may parse the text to identify headers, column names, values, and other relevant information to determine the structure of the dataset. By monitoring user interactions with the GUI, e.g., clicks, selections, scrolling, the system can infer which elements are datasets. For example, if a user selects a range of cells in a table, the system can identify that action as interacting with a dataset. The system may use contextual information from user actions to understand the purpose of the data. For example, dragging a selection box over a table might indicate the user is selecting data.

In one or more embodiments, the system uses semantic analysis to determine relationships between different GUI elements. For instance, when a chart is labeled “Hemoglobin A1C,” the system infers that the underlying data represents lab results for A1C. The system may use templates or heuristics based on common GUI layouts (e.g., forms, dashboards) to identify datasets. For example, if a typical report layout includes a table with a title above the table, the system may use this structure to identify the table as a dataset. Machine learning models can be trained on annotated GUI images where datasets have been labeled. The system learns to recognize similar patterns in new GUIs.

In one or more embodiments, the system recognizes the formatting of data, e.g., CSV, JSON displayed as text, Excel-like grids. Format recognition involves understanding delimiters, rows, and columns, especially in cases where the data is presented in a structured format. Extracting metadata like column names, data types, and units of measurement from the GUI elements helps the system understand the dataset's structure.

In one or more embodiments, the system has access to backend or underlying data sources, e.g., databases, API calls. The system cross-references the GUI content with these sources to accurately identify datasets. For dynamically loaded data (e.g., data grids that fetch content via API calls as you scroll), the system may track these interactions and recognize datasets based on the data flow between the frontend and backend.

In one or more embodiments, the system monitors the datasets by scraping the GUI to identify the presented datasets. The system may subscribe to an event stream published by the application that includes a copy of the datasets being presented on the GUI. The system may transmit periodic queries to the application intercepting the communication between the database and the application to identify the retrieved datasets. The system may perform deep packet inspection.

One or more embodiments detect a first dataset that satisfies a trigger for applying a first machine learning model to the dataset (Operation 204). The system monitors the datasets provided to the system or displayed on the GUI. When the system determines that a first dataset includes content that satisfies a trigger for generating a response, the system applies a machine learning model to the first dataset.

In one or more embodiments, the system applies a set of rules or a machine learning model to the datasets that are presented within the dashboard to determine whether the dataset satisfies a trigger for generating a message. For example, a machine learning model may be trained with training datasets that include (a) vector embeddings of datasets that are presented and (b) a label indicating whether a new message was created while the dataset was presented. The system applies the machine learning model to a target vector embedding representing a currently displayed dataset to determine whether or not a new message is to be created. A data type of the dataset may be used to determine whether the trigger for generating the message is met. A date associated with the dataset may be used to determine whether the trigger for generating the message is met.

One or more embodiments identify candidate actions based on the first dataset (Operation 206). When the machine learning model is applied to the first dataset, the system determines candidate actions based on the first dataset. Candidate actions may include generating an order for medication or treatment, scheduling an appointment, and/or generating a system-composed message, referral or request for consultation.

In one or more embodiments, the system uses machine learning models to predict potential outcomes and suggest actions based on the predicted outcomes. The system may simulate various scenarios using the dataset to determine actions that result in the best outcomes. The system may use optimization algorithms, .e.g., linear programming, genetic algorithms, to identify the best actions that maximize or minimize a particular objective, e.g., cost, time, efficiency. When there are multiple objectives, the system may generate a set of optimal actions that tradeoff between the objectives. The system may rely on rules of thumb or expert knowledge to suggest actions. The system may simulate the decision-making process of a human expert, using knowledge base and inference engine to suggest actions based on the dataset.

One or more embodiments present a set of interface elements for initiating the candidate actions (Operation 208). The system presents interface elements for selecting a candidate action by a clinician. The interface elements may include a first interface element for executing a first action, e.g., generating a medial order, a second interface element for executing a second action, e.g., generating a system-composed message, and a third interface element for executing a third action, e.g., scheduling a follow-up appointment.

In one or more embodiments, the system evaluates the potential costs and benefits of each candidate action and prioritize those with the highest expected benefit, lowest cost, most immediate results, greatest long term potential, least disruptive. Actions may be evaluated based on associated risks, with the system recommending actions that minimize risk. The interface elements may be arranged in order based on criteria, e.g., impact, feasibility, or alignment with objectives. The interface elements may be grouped by patient, task, and/or action.

One or more embodiments determine if a selection of an interface element for initiating a candidate action was received (Operation 210). The system monitors the interface elements and detects when a clinician selects an interface element. Selection of an interface element may include clicking on or otherwise engaging the interface element. If no selection is received, the system continues to monitor the datasets presented in the GUI.

One or more embodiments initiate the action (Operation 212). When the system detects selection of an interface element, the system initiates the action represented by the interface element. Initiating an action for changing patient medication, i.e., placing an order for a new medication or updating a current medication, may include launching an order management system. Initiating an action for scheduling an appointment may include opening a scheduling application. Initiating an action for a referral may include opening a direct messaging application.

In one or more embodiments, selection of an interface element for generating a system-composed message launches a message generation tool. The message generation tool generates a system-composed message that is responsive to the first dataset. The message generation tool uses the content of the first dataset and other patient information, e.g., contact information, patient history, retained within a database record to generate the system-composed message. An interface of the message generation tool may allow the clinician to revise or otherwise amend the system-composed message. An interface element within the interface of the message generation tool is provided for the clinician to send the message.

In one or more embodiments, the message generation tool presents dropdown menus or selection boxes. The dropdown menus and selection boxes provide the clinician with alternative medications, treatments, language, patient instructions, etc. The message generation tool may be configured to use particular terminology in messages to patients and different terminology in messages to other medical professionals. The message generation tool may include options for regenerating the system-composed message. For example, the clinician may decide that the system-composed message includes too much detail, or uses terminology not suitable for the patient, e.g., overly complex. Regeneration of the system-composed message would reduce the amount of detail and/or use terminology more appropriate for the patient. Message regeneration may be used to make a message more sympathetic or less formal.

In one or more embodiments, the system generates messages that are customized based on individual patient needs, ensuring that the communication is relevant and specific to the case. The system-composed message may be tailored based on clinician preferences or past responses, improving the relevance and efficiency of communication. The system-composed message may ensure that the patient receives timely and accurate updates on their health status, leading to better engagement and adherence to treatment plans. The system-composed messages may include educational resources, helping the patient better understand their conditions and the importance of following prescribed care.

In one or more embodiments, the system uses revisions made to the system-composed message by the clinician to update the training data used to train the machine learning model. The system uses the updated training data to retrain the machine learning model. The system may use feedback provided by the clinician or independent reviewers to retrain the machine learning model.

### 4. Determining and Displaying Datasets Relevant to Incoming and Outgoing Messages

One or more embodiments generate and display datasets relevant to (a) an incoming message that is being viewed by a user or (b) an outgoing message that is being composed by a user and/or the system. More particularly, viewing of an incoming message or composing of an outgoing message may trigger the system to analyze the content and/or context of the message, determine datasets within or relevant to the message, and display the datasets for viewing by the clinician. The system may employ a combination of data analysis, machine learning, and information retrieval techniques for determining and displaying relevant datasets.

One or more embodiments parse a message for content, context, intent, and key entities. NLP may be used to extract meaningful information like named entities, e.g., procedures, ailments, medications or dates, keywords, and/or phrases. The text may be cleaned by removing unnecessary characters, stop words, and irrelevant information to improve analysis accuracy.

One or more embodiments analyze the content and context of messages. NLP tools, e.g., named entity recognition or topic modeling, to identify key topics, people, dates, and other entities in the messages. The system may identify which aspects of the message align with known types of datasets by mapping the keywords or entities. The system may convert the message into a semantic vector using algorithms like Word2Vec, BERT, or GPT embeddings. Vectorization allows for comparing the meaning of the message to datasets that are also represented as vectors. The system may run a similarity search, e.g., cosine similarity, against existing datasets to find the most relevant ones based on the content and context of the message. The system may take into account previous messages or ongoing conversations to match datasets that are contextually relevant. When a message mentions specific timeframes, the system may look for datasets with time-sensitive data.

Once relevant datasets have been matched, one or more embodiments classify the datasets for display or further use. Each dataset may be enriched with metadata, e.g., data source, last updated. Datasets may be ranked based on relevance, recency, and/or accuracy. More relevant datasets may be prioritized for display.

One or more embodiments may display datasets in different formats depending on the use case. When the dataset is highly structured, the dataset may be displayed as a table with rows and columns, showing key data points. For datasets with numeric or time-series data, the system may display visualizations, e.g., line graphs for sales trends, bar charts for demographics. Visual representations of the datasets assists a clinician in identifying patterns, trends, and insights at a glance. When datasets are large, the system may summarize key points or statistics. Datasets may be displayed in dashboards that allow for interactive, real-time displays that show key data points, metrics, and visualizations in a single interface. The dashboards may be customizable and allow users to focus on specific aspects of the dataset.

One or more embodiments connect to database records or external databases to retrieve preprocessed or pre-indexed datasets that may be continuously updated. Machine learning models may be trained using labeled messages and corresponding relevant datasets, allowing the system to improve its matching capabilities over time. The system may learn from user feedback or interactions, refining its ability to suggest more relevant datasets for future messages. Machine learning may be used to provide predictive or prescriptive insights based on the datasets.

### 5. Dashboard Displaying a System Generated Message

A detailed example is described below for purposes of clarity. Components and/or operations described below should be understood as one specific example that may not be applicable to certain embodiments. Accordingly, components and/or operations described below should not be construed as limiting the scope of any of the claims.

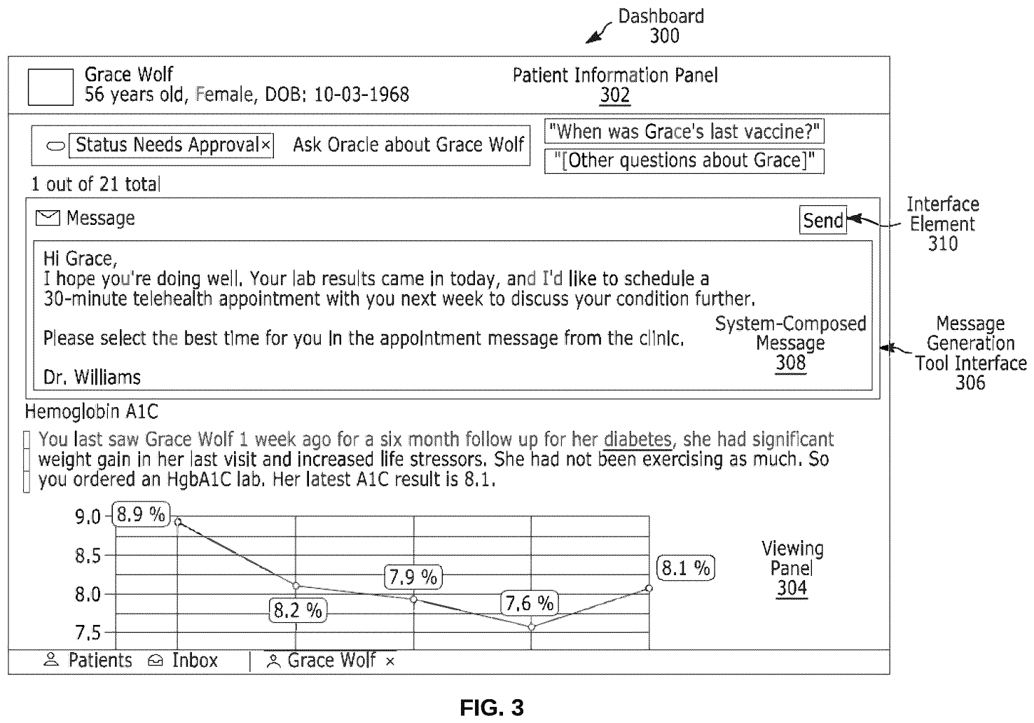

FIG. 3 illustrates a dashboard 300 for patient management. As shown, dashboard 300 includes a patient information panel 302, a viewing panel 304, and a message generation tool interface 306. Patient information panel 302 displays detailed patient information, e.g., patient name, age, sex, and date of birth of the patient. The viewing panel 304 displays results and other medical information associated with the patient. The message generation tool interface 306 displays a system-composed message 308 generated by the system in response to results displayed in the viewing panel 304. The system-composed message 308 may be edited by the clinician within the message generation tool interface 306. The message generation tool interface 306 may include an interface element 310 for sending the system-composed message 308. The system-composed message 308 may be sent by a clinician by selecting the interface element 310.

As detailed in the patient information panel 302, the dashboard 300 displays a patient record for a patient named Grace Wolf. She is a 56-year-old woman born on Oct. 3, 1968. As detailed in the viewing panel 304, lab results for Ms. Wolf indicate an increase in Hemoglobin A1C. Based on the lab results for Ms. Wolf, the system generates the system-composed message 308. The system-composed message 308 informs Ms. Wolf that her tests results were received and requests the scheduling of a follow-up appointment to discuss the test results. The system-composed message 308 may be sent by the clinician by selecting the interface element 310 that reads “Send”.

### 6. Dashboard Displaying System Generated Action Items

A detailed example is described below for purposes of clarity. Components and/or operations described below should be understood as one specific example that may not be applicable to certain embodiments. Accordingly, components and/or operations described below should not be construed as limiting the scope of any of the claims.

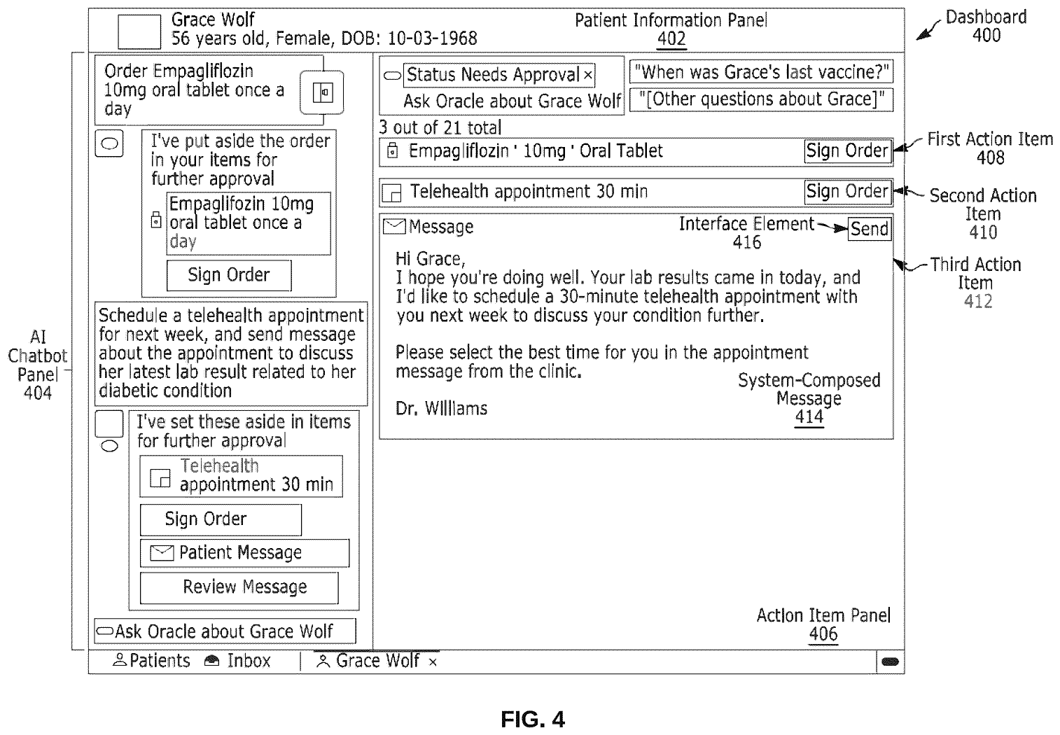

FIG. 4 illustrates a dashboard 400 including a patient information panel 402, an AI Chatbot panel 404, and an action item panel 406. The chat conversation begins with the clinician requesting an order for a medication. The chat conversations continue with the clinician requesting the scheduling of a follow-up appointment with the patient. The clinician also requests a message be sent to the patient detailing the reason for the appointment.

The system monitors the interaction between the clinician and the AI chatbot. In response to the chat conversation, the system generates action items for responding to the chat conversation. A first action item 408 generated in response to the chat conversation is an order for medication. A second action item 410 generated in response to the chat conversation is a follow-up appointment for the patient. A third action item 412 generated in response to the chat conversation is a system-composed message 414.

The clinician may select any or all of the first action item 408, the second action item 410, the third action item 412. Selection of the third action item 412 allows the clinician to revise or otherwise edit the system-composed message 414. Selection of interface element 416 sends the system-composed message 414 to the intended recipient, e.g., Ms. Wolf.

### 7. Practical Applications, Advantages & Improvements

In one or more embodiments, systems that generate system-composed messages for review by a clinician increase efficiency, accuracy, and patient care quality. Automated message generation can significantly reduce time clinicians spend drafting routine communications, allowing clinicians to focus more on direct patient care. The system can prioritize and organize messages, helping clinicians address the most critical issues first and reducing administrative burdens. The system can ensure that messages adhere to standard clinical guidelines and protocols, reducing variability in communication. System-composed messages minimize the risk of human error in message creation, such as typographical errors or incomplete information.

In one or more embodiments, system-composed messages allow for proactive patient management. The system can automatically generate alerts for abnormal lab results, vital signs, or other clinical data, prompting timely intervention by clinicians. Reminders and follow-up messages provided by system-composed messages ensure that patients receive ongoing care, reducing the risk of missed appointments or neglected symptoms.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

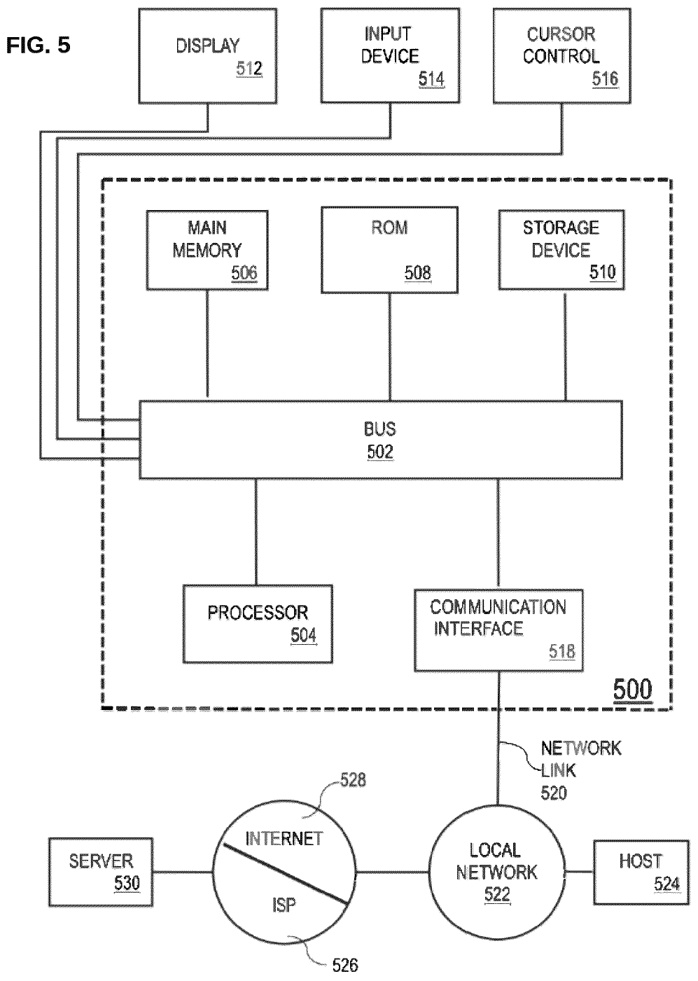

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, causes performance of operations comprising:
obtaining training datasets, wherein a training dataset, of the training datasets, comprises:
a first dataset presented in a first dashboard;
a first message related to the first dataset;
training a first machine learning model to generate system-composed messages based on datasets presented in dashboards;
monitoring, in real-time, datasets presented in a target dashboard;
based on the real-time monitoring, detecting a trigger for applying the first machine learning model to at least a second dataset, of the datasets, presented in the target dashboard;
applying the first machine learning model to the second dataset to generate a system-composed message;
presenting the system-composed message to a user for approval;
receiving feedback corresponding to the system-composed message; and
based on the feedback corresponding to the system-composed message, retraining the first machine learning model.

2. The non-transitory computer readable media of claim 1, wherein monitoring datasets presented in the target dashboard comprises detecting database records being viewed by the user.

3. The non-transitory computer readable media of claim 1, wherein monitoring datasets presented in the target dashboard comprises detecting access to a database record corresponding to the datasets presented in the target dashboard.

4. The non-transitory computer readable media of claim 1, wherein the datasets comprise message attachments that have been received and are accessible via the target dashboard.

5. The non-transitory computer readable media of claim 1, wherein the datasets comprise content of user interaction with a chatbot.

6. The non-transitory computer readable media of claim 1, wherein the operations further comprise:
presenting an interface element, to display a message generation tool, in a set of presented interface elements corresponding respectively to different actions that may be executed by a system,
wherein the system-composed message is presented in the message generation tool in response to receiving user selection of the interface element.

7. The non-transitory computer readable media of claim 1, wherein the feedback corresponding to the system-composed message comprises modifications to content of the system-composed message by the user.

8. A method comprising:
obtaining training datasets, wherein a training dataset, of the training datasets, comprises:
a first dataset presented in a first dashboard;
a first message related to the first dataset;
training a first machine learning model to generate system-composed messages based on datasets presented in dashboards;
monitoring, in real-time, datasets presented in a target dashboard;
based on the real-time monitoring, detecting a trigger for applying the first machine learning model to at least a second dataset, of the datasets, presented in the target dashboard;
applying the first machine learning model to the second dataset to generate a system-composed message;
presenting the system-composed message to a user for approval;
receiving feedback corresponding to the system-composed message; and
based on the feedback corresponding to the system-composed message, retraining the first machine learning model, wherein the method is performed by at least one device including a hardware processor.

9. The method of claim 8, wherein monitoring datasets presented in the target dashboard comprises detecting database records being viewed by the user.

10. The method of claim 8, wherein monitoring datasets presented in the target dashboard comprises detecting access to a database record corresponding to the datasets presented in the target dashboard.

11. The method of claim 8, wherein the datasets comprise message attachments that have been received and are accessible via the target dashboard.

12. The method of claim 8, wherein the datasets comprise content of user interaction with a chatbot.

13. The method of claim 8, further comprising:
presenting an interface element, to display a message generation tool, in a set of presented interface elements corresponding respectively to different actions that may be executed by a system,
wherein the system-composed message is presented in the message generation tool in response to receiving user selection of the interface element.

14. The method of claim 8, wherein the feedback corresponding to the system-composed message comprises modifications to the system-composed message by the user.

15. A system comprising:
at least one device including a hardware processor;
the system being configured to perform operations comprising:
obtaining training datasets, wherein a training dataset, of the training datasets, comprises:
a first dataset presented in a first dashboard;
a first message related to the first dataset;
training a first machine learning model to generate system-composed messages based on datasets presented in dashboards;
monitoring, in real-time, datasets presented in a target dashboard;
based on the real-time monitoring, detecting a trigger for applying the first machine learning model to at least a second dataset, of the datasets, presented in the target dashboard;
applying the first machine learning model to the second dataset to generate a system-composed message;
presenting the system-composed message to a user for approval;
receiving feedback corresponding to the system-composed message; and
based on the feedback corresponding to the system-composed message, retraining the first machine learning model.

16. The system of claim 15, wherein monitoring datasets presented in the target dashboard comprises detecting database records being viewed by the user.

17. The system of claim 15, wherein monitoring datasets presented in the target dashboard comprises detecting access to a database record corresponding to the datasets presented in the target dashboard.

18. The system of claim 15, wherein the datasets comprise message attachments that have been received and are accessible via the target dashboard.

19. The system of claim 15, wherein the datasets comprise content of user interaction with a chatbot.

20. The system of claim 15, wherein the operations further comprise:
presenting an interface element, to display a message generation tool, in a set of presented interface elements corresponding respectively to different actions that may be executed by a system,
wherein the system-composed message is presented in the message generation tool in response to receiving user selection of the interface element.
